(19) United States
(12) Patent Application Publication
(10) Pub. No.: US 2010/0311401 A1
(43) Pub. Date: Dec. 9, 2010

(54) COMMUNICATION SESSION TRANSFER FROM ONE COMMUNICATION DEVICE TO ANOTHER BASED ON LOCATION CORRELATED TO TIME

(75) Inventors: DaeSik Oh, Overland Park, KS (US); Lyle Walter Paczkowski, Mission Hills, KS (US); Robert C. Pippert, Lenexa, KS (US)

Correspondence Address: SPRINT, 6391 SPRINT PARKWAY, KSOPHT0101-Z2100, OVERLAND PARK, KS, 66251-2100, US

(73) Assignee: Sprint Communications Company L.P., Overland Park, KS (US)

(21) Appl. No.: 12/481,283

(22) Filed: Jun. 9, 2009

(51) Int. Cl. H04M 3/42

(52) U.S. Cl. 455/417

(57) ABSTRACT

A communication network receives communications for a wireless communication device and transfers the communications for delivery to the wireless communication device. The wireless communication device determines data that correlates its location to time. Either the wireless communication device or the communication network process the data to detect a transfer condition that comprises the wireless communication device being located within a predetermined area for a predetermined period of time. If the transfer condition applies, then the communication network transfers communications for the wireless device for delivery to another communication device. When the transfer condition no longer applies, the communication network again transfers communications for the wireless communication device for delivery to the wireless communication device.

### TECHNICAL BACKGROUND

A wireless communication device can determine its location through Global Positioning System (GPS) signal processing. The wireless communication device can also request that communications directed to it be redirected to another device by requesting the redirection from a call forwarding platform. The call forwarding platform may be automated to implement call forwarding when the wireless communication device is turned off. In addition, the wireless communication device may be configured to request call forwarding when it receives a wireless signal from a nearby communication device.

### OVERVIEW

A communication network receives communications for a wireless communication device and transfers the communications for delivery to the wireless communication device. The wireless communication device determines data that correlates its location to time. Either the wireless communication device or the communication network process the data to detect a transfer condition that comprises the wireless communication device being located within a predetermined area for a predetermined period of time. If the transfer condition applies, then the communication network transfers communications for the wireless device for delivery to another communication device. When the transfer condition no longer applies, the communication network again transfers communications for the wireless communication device for delivery to the wireless communication device.

### BRIEF DESCRIPTION OF THE DRAWINGS

FIG. 1 illustrates a communication system.

FIG. 2 illustrates the operation of the communication system.

FIG. 3 illustrates the operation of the communication system.

FIG. 4 illustrates a communication system having a wireless communication device and a network gateway.

FIG. 5 illustrates a communication system having a wireless communication device and a network gateway.

FIG. 6 illustrates a wireless communication device.

FIG. 7 illustrates the operation of the wireless communication device.

FIG. 8 illustrates a network gateway.

FIG. 9 illustrates the operation of the network gateway.

### DETAILED DESCRIPTION

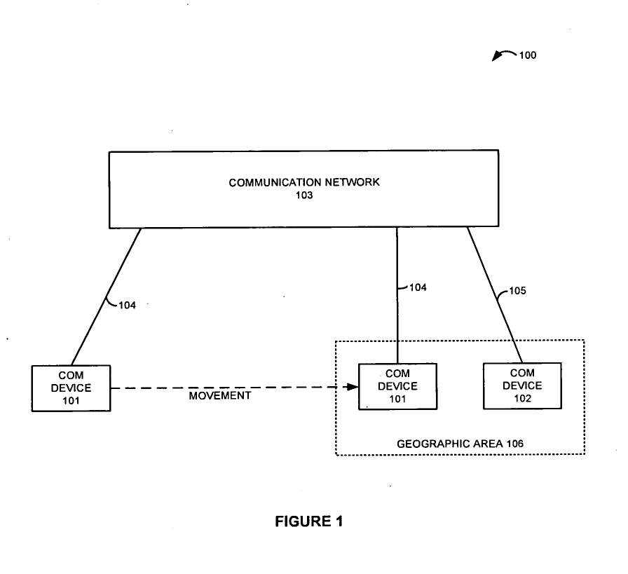

FIG. 1 illustrates communication system 100. Communication system 100 includes communication devices 101-102 and communication network 103. Communication device 101 and communication network 103 communicate over wireless communication link 104. Communication device 102 and communication network 103 communicate over communication link 104. As indicated by the dashed arrow, communication device 101 moves into predetermined geographic area 106, and the physical presence of communication device 101 in geographic area 106 for a predetermined period of time triggers the communication between communication device 102 and communication network 103. Geographic area 106 may be large, but it typically comprises a relatively small area, such as a residence, office, room, or even a desktop.

Communication device 101 comprises a wireless communication device, such as a telephone, internet appliance, computer, game console, television, media player, e-book, or some other apparatus capable of wireless communication and location determination. Communication device 102 comprises a communication device that may or may not be wireless, with examples including a telephone, internet appliance, computer, game console, television, media player, e-book, or some other apparatus capable of media communication. The communications could be voice calls, e-mail, text message, web pages, video, music, data messages, or some other media content.

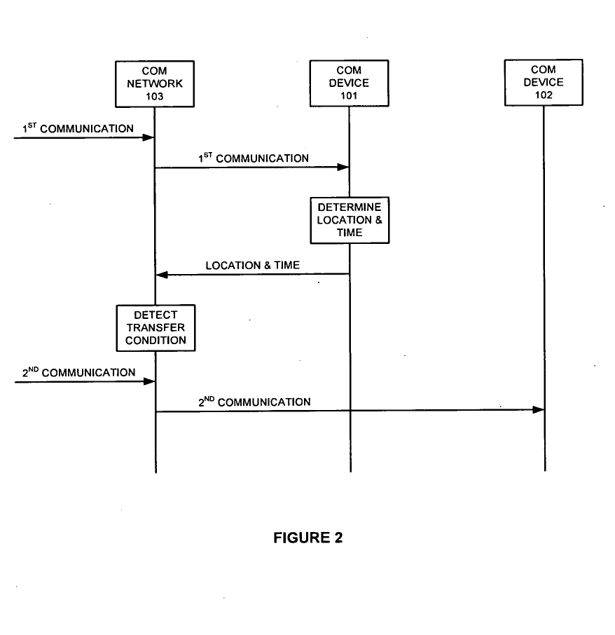

FIG. 2 illustrates the operation of communication system 100 in some embodiments, although other alternative embodiments are described herein as well. The operation starts when communication network 103 receives a first communication directed to wireless communication device 101. In response, communication network 103 transfers the first communication over wireless communication link 104 for receipt by wireless communication device 101. Wireless communication device 101 periodically determines its geographic location correlated to time and periodically transfers data that indicates these geographic locations correlated to time over wireless communication link 104 for receipt by communication network 103.

Communication network 103 receives the data transferred by wireless communication device 101 and processes the geographic locations correlated to time to detect a transfer condition. The transfer condition comprises wireless communication device 101 being located within predetermined geographic area 106 for a predetermined period of time—and remaining within geographic area 106. Thus, the transfer condition applies after wireless communication device 101 has been located within geographic area 106 for the period of time, but the transfer condition no longer applies when wireless communication device 101 subsequently leaves geographic area 106.

In this example, wireless communication device 101 moves to geographic area 106 and stays there for the predetermined period of time, so the transfer condition applies as long as wireless communication device 101 remains within geographic area 106. While the transfer condition applies, communication network 103 receives a second communication directed to wireless communication device 101. Due to the transfer condition, communication network 103 transfers the second communication over communication link 105 for receipt by communication device 102.

Although not shown, communication network 103 would transfer subsequent communications to wireless communication device 101 when wireless communication device 101 leaves geographic area 106, since the transfer condition would no longer apply. Although not required, communication network 103 may transfer communications to both wireless communication device 101 and communication device 102 during the transfer condition to provide the communications contemporaneously to both devices 101-102.

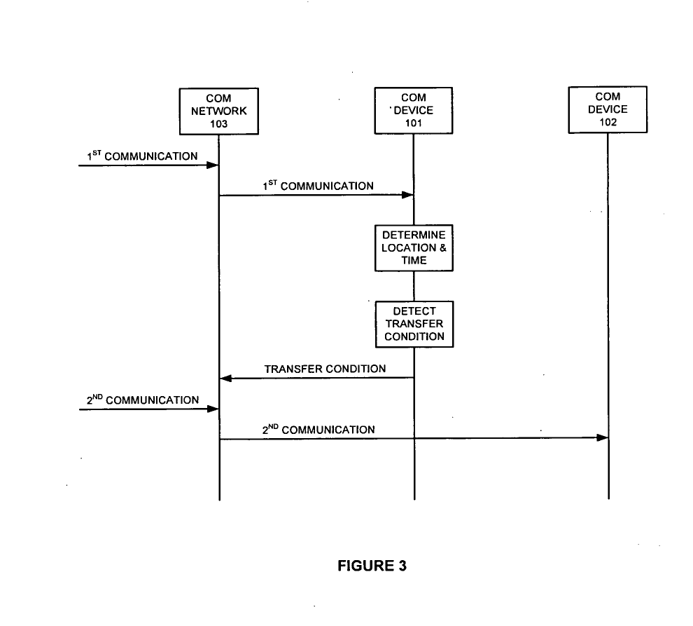

FIG. 3 illustrates the operation of communication system 100 in some embodiments, although other alternative embodiments are described herein as well. The operation starts when communication network 103 receives a first communication directed to wireless communication device 101. In response, communication network 103 transfers the first communication over wireless communication link 104 for receipt by wireless communication device 101. Wireless communication device 101 periodically determines its geographic location correlated to time and processes the data to detect a transfer condition. The transfer condition comprises wireless communication device 101 being located within predetermined geographic area 106 for a predetermined period of time—and remaining within geographic area 106. Thus, the transfer condition applies after wireless communication device 101 has been located within geographic area 106 for the period of time, but the transfer condition no longer applies when wireless communication device 101 subsequently leaves geographic area 106.

In this example, wireless communication device 101 moves to geographic area 106 and stays there for the predetermined period of time, so the transfer condition applies as long as wireless communication device 101 remains within geographic area 106. In response to the transfer condition, wireless communication device 101 transfers information over wireless communication link 104 for receipt by communication network 103 indicating that the transfer condition applies. Communication network 103 receives the information indicating that the transfer condition applies. During the transfer condition, communication network 103 receives a second communication directed to wireless communication device 101. Due to the transfer condition, communication network 103 transfers the second communication over communication link 105 for receipt by communication device 102.

Although not shown, wireless communication device 101 transfers additional information to communication network 103 indicating that the transfer condition no longer applies when wireless communication device 101 leaves geographic area 106. Communication network 103 would again transfer subsequent communications to wireless communication device 101 since the transfer condition would no longer apply. Although not required, communication network 103 may transfer communications to both wireless communication device 101 and communication device 102 during the transfer condition to provide the communications contemporaneously to both devices 101-102.

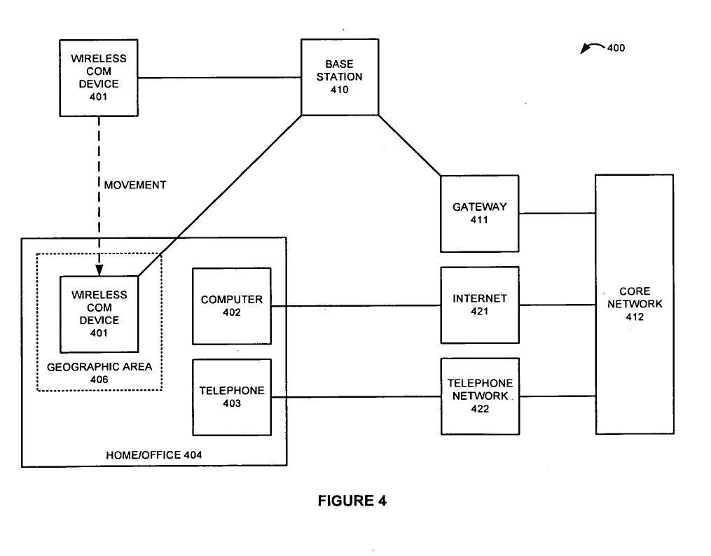

FIG. 4 illustrates communication system 400. Communication system 400 is an example of communication system 100, although communication system 100 may have alternative configurations. Wireless communication device 401 repeatedly determines its geographic location and transfers time-stamped location data through base station 410 to network gateway 411. The location may be specified by latitude and longitude or some other coordinate system. Network gateway 411 maintains a database that relates wireless communication device 401 to predetermined geographic area 406, a predetermined time period, and a communication session type. Geographic area 406 could be a relatively small area that is less than 150 square feet, and the predetermined time period could be more than one minute, such as 90 seconds—although other area sizes and time periods could be used. The location of device 401 and the boundary of area 406 may be specified by latitude and longitude or some other coordinate system.

Network gateway 411 processes the time-stamped location data and information from the database to detect if a transfer condition applies. The transfer condition applies if wireless communication device 401 has been located within geographic area 406 for the predetermined period of time and remains in geographic area 406. The transfer condition does not apply if wireless communication device 401 is not located within geographic area 406 or has not remained within geographic area 406 for the predetermined period of time.

Wireless communication device 401 is initially located near base station 410 and then moves to predetermined geographic area 406 within home/office 404. Before wireless communication device 401 moves to geographic area 406, network gateway 411 determines that the transfer condition does not apply. After wireless communication device 401 relocates to geographic area 406 for the time period, network gateway 411 determines that the transfer condition applies.

In a first example, the database maintained by network gateway 411 also associates the transfer condition for wireless communication device 401 with voice calls and with telephone 403. When the transfer condition does not apply, network gateway 411 receives voice calls for wireless communication device 401 from telephone network 422 through core network 412 and transfers these voice calls through base station 410 to wireless communication device 401. When the transfer condition does apply, network gateway 411 receives voice calls for wireless communication device 401 from telephone network 422 through core network 412 and transfers these voice calls back through core network 412 and telephone network 422 to telephone 403. Even when the transfer condition applies, gateway 411 would still transfer other types of communications directed to wireless communication device 401, such as text messages and emails, through base station 410 to wireless communication device 401. Thus, the transfer condition is applied on a communication session type basis.

In a second example, wireless communication device 401 and computer 402 are each configured with a Voice over Internet Protocol (VoIP) application, and wireless communication device 401 and computer 402 each have a VoIP address. The database maintained by network gateway 411 associates wireless communication device 401 with its VoIP address, and the database associates the transfer condition for wireless communication device 401 with VoIP calls and with the VoIP address of computer 402. To maintain the database associations, wireless communication device 401 and computer 402 may report their VoIP addresses to network gateway 411, wireless communication device 401 may obtain and report both VoIP addresses to network gateway 411, or network gateway 411 may obtain the VoIP addresses of wireless communication device 401 and computer 402 using some other technique.

When the transfer condition does not apply, network gateway 411 receives VoIP calls for wireless communication device 401 from internet 421 through core network 412 and transfers these VoIP calls through base station 410 to wireless communication device 401. Thus, network gateway 411 transfers the VoIP traffic using the VoIP address of wireless communication device 401 when the transfer condition does not apply. When the transfer condition does apply, network gateway 411 receives VoIP calls for wireless communication device 401 from internet 421 through core network 412 and transfers these VoIP calls back through core network 412 and internet 421 to computer 402. Thus, network gateway 411 transfers the VoIP traffic using the VoIP address of computer 402 when the transfer condition does apply. Even when the transfer condition applies, gateway 411 would still transfer other types of communications directed to wireless communication device 401, such as text messages and emails, through base station 410 to wireless communication device 401. Thus, the transfer condition is applied on a communication session type basis.

In a third example, wireless communication device 401 and computer 402 are each configured with a video application, and wireless communication device 401 and computer 402 each have an internet address. The database maintained by network gateway 411 associates wireless communication device 401 with its internet address, and the database associates the transfer condition for wireless communication device 401 with video and with the internet address of computer 402. To maintain the database associations, wireless communication device 401 and computer 402 may report their internet addresses to network gateway 411, wireless communication device 401 may obtain and report both internet addresses to network gateway 411, or network gateway 411 may obtain the internet addresses of wireless communication device 401 and computer 402 using some other technique.

When the transfer condition does not apply, network gateway 411 receives video for wireless communication device 401 from internet 421 through core network 412 and transfers the video through base station 410 to wireless communication device 401. Thus, network gateway 411 transfers the video traffic using the internet address of wireless communication device 401 when the transfer condition does not apply. When the transfer condition does apply, network gateway 411 receives video for wireless communication device 401 from internet 421 through core network 412 and transfers the video back through core network 412 and internet 421 to computer 402. Thus, network gateway 411 transfers the video traffic using the internet address of computer 402 when the transfer condition does apply. Even when the transfer condition applies, gateway 411 would still transfer other types of communications directed to wireless communication device 401, such as voice calls and text messages, through base station 410 to wireless communication device 401. Thus, the transfer condition is applied on a communication session type basis.

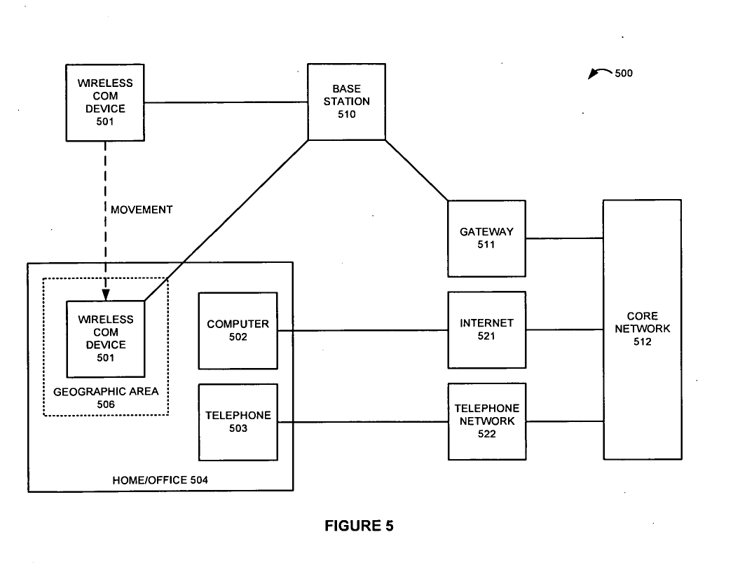

FIG. 5 illustrates communication system 500. Communication system 500 is an example of communication system 100, although communication system 100 may have alternative configurations. Wireless communication device 501 repeatedly determines its geographic location and time-stamps the location data. Wireless communication device 501 stores transfer-condition data that relates predetermined geographic area 506 to a predetermined time period and to a session type. For example, geographic area 506 could be a bedroom, and the predetermined time period could be 90 seconds—although other area sizes and time periods could be used. The location of device 501 and the boundary of area 506 may be specified by latitude and longitude or some other coordinate system.

Wireless communication device 501 processes the time-stamped location data and transfer-condition data to detect if a transfer condition applies. The transfer condition applies if wireless communication device 501 has been located within geographic area 506 for the predetermined period of time and remains in geographic area 506. The transfer condition does not apply if wireless communication device 501 is not located within geographic area 506 or has not remained within geographic area 506 for the predetermined period of time.

Wireless communication device 501 is initially located near base station 510 and then moves to predetermined geographic area 506 within home/office 504. Before wireless communication device 501 moves to geographic area 506, wireless communication device 501 determines that the transfer condition does not apply. After wireless communication device 501 relocates to geographic area 506 for the time period, wireless communication device 501 determines that the transfer condition applies. Wireless communication device 501 transfers messages through base station 510 to network gateway 511 indicating whether or not the transfer condition applies. These messages may also include transfer instructions regarding session type, addressing, and formatting for the session transfer.

In a first example, the transfer-condition data maintained by wireless communication device 501 also associates the transfer condition with voice calls and with telephone 503. When the transfer condition does not apply, network gateway 511 receives voice calls for wireless communication device 501 from telephone network 522 through core network 512 and transfers these voice calls through base station 510 to wireless communication device 501.

When the transfer condition applies, wireless communication device 501 sends an instruction to network gateway 511 indicating that subsequent voice calls should be routed to the number of telephone 503. Network gateway 511 receives voice calls for wireless communication device 501 from telephone network 522 through core network 512 and transfers these voice calls back through core network 512 and telephone network 522 to telephone 503.

When the transfer condition no longer applies, wireless communication device 501 sends an instruction to network gateway 511 indicating that subsequent voice calls should be routed to wireless communication device 501. Network gateway 511 receives subsequent voice calls for wireless communication device 501 from telephone network 522 through core network 512 and transfers these voice calls through base station 510 to wireless communication device 501.

In a second example, wireless communication device 501 and computer 502 are each configured with a Voice over Internet Protocol (VoIP) application and wireless communication device 501 and computer 502 each have a VoIP address. The transfer-condition data maintained by wireless communication device 501 associates the transfer condition with VoIP calls and with the VoIP address of computer 502. To maintain the data association, wireless communication device 501 may obtain the VoIP address of computer 502 from computer 502, network gateway 511, or through some other technique.

When the transfer condition does not apply, network gateway 511 receives VoIP calls for wireless communication device 501 from internet 521 through core network 512 and transfers these VoIP calls through base station 510 to wireless communication device 501. Thus, network gateway 511 transfers the VoIP traffic using the VoIP address of wireless communication device 501 when the transfer condition does not apply. When the transfer condition does apply, network gateway 511 receives VoIP calls for wireless communication device 501 from internet 521 through core network 512 and transfers these VoIP calls back through core network 512 and internet 521 to computer 502. Thus, network gateway 511 transfers the VoIP traffic using the VoIP address of computer 502 when the transfer condition does apply.

In a third example, wireless communication device 501 and computer 502 are each configured with a video application, and wireless communication device 501 and computer 502 each has an internet address. The transfer-condition data maintained by wireless communication device 501 associates wireless communication device 501 with its internet address, and associates the transfer condition for wireless communication device 501 with video and with the internet address of computer 502. To maintain the data association, wireless communication device 501 may obtain the internet address of computer 502 from computer 502, network gateway 511, or through some other technique.

When the transfer condition does not apply, network gateway 511 receives video for wireless communication device 501 from internet 521 through core network 512 and transfers the video through base station 510 to wireless communication device 501. Thus, network gateway 511 transfers the video traffic using the internet address of wireless communication device 501 when the transfer condition does not apply. When the transfer condition does apply, network gateway 511 receives video for wireless communication device 501 from internet 521 through core network 512 and transfers the video back through core network 512 and internet 521 to computer 502. Thus, network gateway 511 transfers the video traffic using the internet address of computer 502 when the transfer condition does apply.

There are variations to the above examples that could be implemented during a transfer condition. The network gateways may transfer the communications contemporaneously to both communication devices. The network gateways might transfer VoIP calls from the internet to the telephone over the telephone network by converting the calls between VoIP and telephony formats. Likewise, the network gateways might transfer voice calls from the telephone network to the computer over the internet by converting the calls between the telephony and VoIP formats. In a similar manner, the network gateways might reformat video or request video re-formatting from a video server.

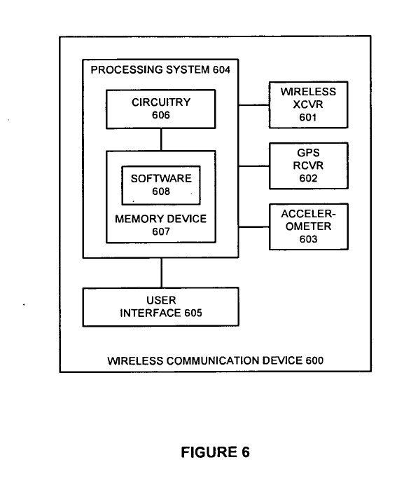

FIG. 6 illustrates wireless communication device 600. Wireless communication device 600 is an example of wireless communication devices 101, 401, and 501, although devices 101, 401, and 501 may use alternative configurations. Wireless communication device 600 comprises wireless transceiver 601, Global Positioning System (GPS) receiver 602, accelerometer 603, processing system 604, and user interface 605. Processing system 604 comprises processing circuitry 606 and memory device 607 that stores operating software 608. Processing system 604 is linked to wireless transceiver 601, GPS receiver 602, accelerometer 603, and user interface 605. Wireless communication device 600 may include other well-known components that are not shown for clarity, such as a battery, camera, and enclosure.

Wireless transceiver 601 comprises an antenna, RF transceiver, signal processing circuitry, software, and/or some other wireless communication components. Wireless transceiver 601 may use various protocols, such as Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other wireless communication format—including combinations thereof. Wireless transceiver 601 exchanges media, such as voice and video, with a communication network. In some examples, wireless transceiver 601 transmits location and time data to the communication network. In other examples, wireless transceiver 601 transmits transfer condition status information and other transfer data to the communication network as described herein.

GPS receiver 602 comprises an antenna, RF receiver, signal processing circuitry, software, and/or some other satellite communication components. GPS receiver 602 receives and processes GPS signals from GPS satellites to produce geographic coordinates that specify the current geographic location of wireless communication device 600.

Accelerometer 603 comprises circuitry and sensors that detect the acceleration of wireless communication device 600 relative to earth's gravitational field. By starting with a known GPS position and by processing acceleration and time data, processing system 604 can maintain an accurate location of wireless communication device 600, even if GPS signals become blocked due to movement or structural interference.

User interface 605 comprises components that interact with a user. User interface 805 may include buttons, lights, display, touch screen, or some other user input/output apparatus—including combinations thereof.

Processing circuitry 606 comprises microprocessor and other circuitry that retrieves and executes operating software 608 from memory device 607. Memory device 607 comprises a computer-readable storage medium, such as a disk drive, flash drive, data storage circuitry, or some other memory apparatus. Memory device 607 may also store transfer condition data that associates device 600 with a predetermined geographic area, time period, and session type, and also with other communication devices, device numbers, or device addresses. Processing circuitry 606 is typically mounted on a circuit board that may also hold memory device 607 and portions of user interface 605 and components 601-603.

The transfer condition data may be acquired through a process where the user moves wireless communication device 600 to physically map and record the boundaries of the predetermined geographic area. The user may also select and input the predetermined time period, the session types for the transfer condition, and the identity or address of the other communication device that receives communications during the transfer condition.

Operating software 608 comprises computer programs, firmware, or some other form of computer-readable processing instructions. Operating software 608 may include an operating system, utilities, drivers, network interfaces, applications, or some other type of software. When executed by processing circuitry 606, operating software 608 directs processing system 604 to operate wireless communication device 600 as described herein for wireless communication devices 101, 401, and/or 501. In some examples, operating software 608 directs processing system 604 to transfer location and time data to a communication network as described herein. In other examples, operating software 608 directs processing system 604 to process location and time data to detect if a transfer condition applies, and to transmit transfer condition status information and other transfer data to a communication network as described herein.

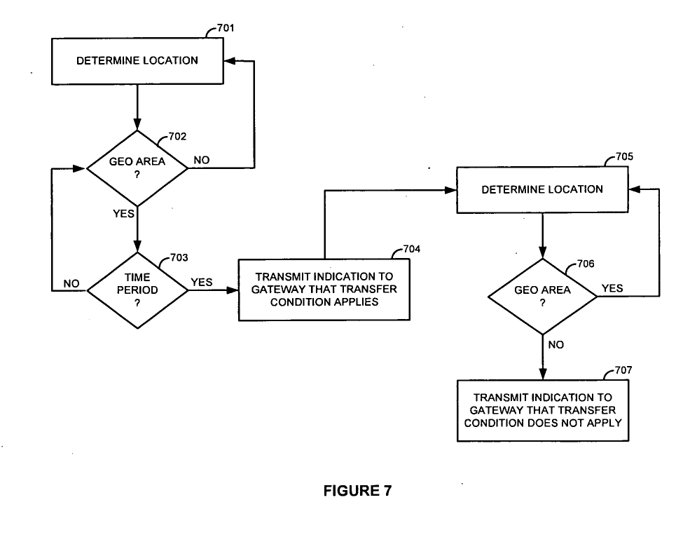

FIG. 7 illustrates the operation of wireless communication device 600 in examples where device 600 detects the transfer condition. Wireless communication device 600 repeatedly determines its location (701). Wireless communication device 600 processes the location to determine if device 600 is within a predetermined geographic area (702). This determination entails a comparison of the location coordinates to the area boundary coordinates to detect when the location coordinates fall within the range of the boundary coordinates. If wireless communication device 600 enters the geographic area (702), then device 600 processes the time and location to determine if device 600 has remained in the geographic area for a predetermined time period (703). If wireless communication device 600 has remained in the geographic area for the predetermined time period (703), then device 600 transfers an indication to a network gateway that a transfer condition applies (704). The indication may also identify session type and another communication device by name, address, or number. Wireless communication device 600 continues to determine its location (705). Wireless communication device 600 processes the location to determine if device 600 has left the predetermined geographic area (706). If wireless communication device 600 leaves the geographic area (706), then device 600 transfers an indication to the network gateway that the transfer condition no longer applies.

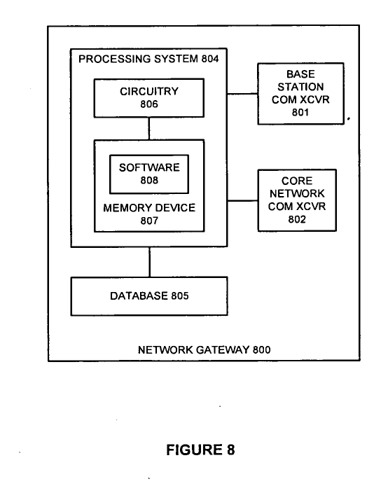

FIG. 8 illustrates network gateway 800. Network gateway 800 is an example of communication network 103, network gateway 411, and network gateway 511, although these systems may use alternative configurations. Network gateway 800 comprises base station transceiver 801, core network transceiver 802, processing system 804, and database 805. Processing system 804 comprises processing circuitry 806 and memory device 807 that stores operating software 808. Processing system 804 is linked to transceivers 801-802 and database 805. Network gateway 800 may include other well-known components that are not shown for clarity, such as authorization and accounting systems, data service nodes, application servers, firewalls, switching systems, and routers.

Transceivers 801-802 comprise physical communication ports, signal processing circuitry, software, and/or some other communication components. Transceivers 801-802 may use various protocols, such as Time Division Multiplex, (TDM), optical networking, Internet Protocol (IP), wireless microwave, or some other communication format—including combinations thereof. Transceivers 801-802 exchange media, such as voice and video, with various communication systems and networks. In some examples, transceiver 801 receives location and time data from a wireless communication device through a base station as described herein. In other examples, transceiver 801 receives transfer condition status information and other transfer data from a wireless communication device through a base station as described herein.

Database 805 comprises a computer-readable storage medium, such as a disk drive, data storage circuitry, or some other memory apparatus. Database 805 stores transfer condition data that individually associates wireless communication devices with predetermined geographic areas, time periods, session types, and other communication devices, device numbers, or device addresses.

Processing circuitry 806 comprises microprocessor and other circuitry that retrieves and executes operating software 808 from memory device 807. Memory device 807 comprises a computer-readable storage medium, such as a disk drive, flash drive, data storage circuitry, or some other memory apparatus. Processing circuitry 806 is typically mounted on a circuit board that may also hold memory device 807 and portions of components 801-802 and 805.

Operating software 808 comprises computer programs, firmware, or some other form of computer-readable processing instructions. Operating software 808 may include an operating system, utilities, drivers, network interfaces, applications, or some other type of software. When executed by processing circuitry 806, operating software 808 directs processing system 804 to operate network gateway 800 as described herein for communication network 103 and/or network gateways 411 and 511. In some examples, operating software 808 directs processing system 804 to process location and time data to detect transfer conditions and responsively re-route communication traffic as described herein. In other examples, operating software 808 directs processing system 804 to process transfer condition status information and other transfer data to re-route communication traffic as described herein.

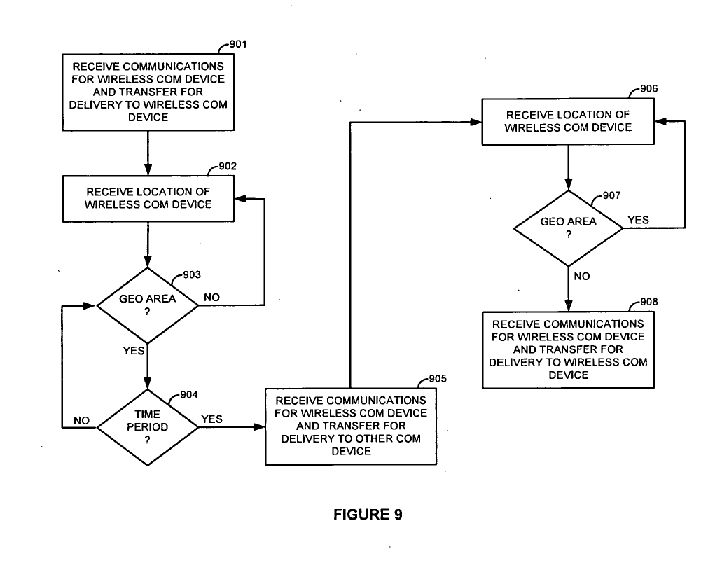

FIG. 9 illustrates the operation of network gateway 800 in examples where network gateway 800 detects the transfer condition and re-routes communication traffic. Network gateway 800 receives communications for a wireless communication device and transfers the communications for delivery to the wireless communication device—typically in a wireless format through a base station (901). Network gateway 800 repeatedly receives location and time information for the wireless communication device (902). Network gateway 800 processes the location and time information to determine if the wireless communication device is within its predetermined geographic area (903). If the wireless communication device enters its geographic area (903), then network gateway 800 processes the time and location information to determine if the wireless communication device has remained in the geographic area for a predetermined time period (904). If wireless communication device 600 has remained in the geographic area for the predetermined time period (904), then network gateway 800 receives communications for the wireless communication device and transfers these communications for delivery to another communication device—perhaps in a different format or over a different network (905).

Network gateway 800 continues to receive time and location information for the wireless communication device (906). Network gateway 800 processes the location to determine if the wireless communication device has left its predetermined geographic area (907). If the wireless communication device leaves its geographic area (907), then network gateway 800 again receives communications for the wireless communication device and transfers these communications for delivery to the wireless communication device—typically in the wireless format through the base station (908).

Referring back to FIG. 1, communication device 101 comprises an antenna and RF communication circuitry for wireless communication. The RF communication circuitry typically includes an amplifier, filter, RF modulator, and signal processing circuitry. Communication device 101 also comprises processing circuitry, memory, software, and a user interface. Communication device 102 comprises a communication transceiver, processing circuitry, memory, software, and a user interface.

Communication network 103 comprises antennas and RF communication circuitry for wireless communication. The RF communication circuitry typically includes an amplifier, filter, RF modulator, and signal processing circuitry. Communication network 103 also comprises communication equipment and communication links. The equipment may include call processors, routers, servers, switches, memory devices, software, processing circuitry, cabling, power supplies, communication interfaces, and other communication apparatus—including combinations thereof. Communication network 103 may be a single discreet system or may be comprised of multiple systems and networks. For example, communication network 103 may include telephony networks, data networks, the Internet, and other systems.

Wireless link 104 uses the air or space as the transport media. Wireless link 104 may use various protocols, such as Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other wireless communication format.

Communication link 105 uses metal, glass, air, space, or some other material as the transport media. Communication link 105 could use various communication protocols, such as Time Division Multiplex (TDM), Internet Protocol (IP), Ethernet, communication signaling, CDMA, EVDO, WIMAX, GSM, LTE, WIFI, HSPA, or some other communication format—including combinations thereof. Communication link 105 could be a direct link or may include intermediate networks, systems, or devices.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a communication network comprising:
in the communication network, receiving first communications directed to a wireless communication device and transferring the first communications for receipt by the wireless communication device;
in the communication network, receiving data transferred by the wireless communication device, wherein the data indicates geographic locations of the wireless communication device correlated to time, and processing the data to detect a transfer condition that comprises the wireless communication device being located within a predetermined area for a predetermined period of time and remaining within the predetermined area;
in the communication network, receiving second communications directed to the wireless communication device, transferring the second communications for receipt the wireless communication device if the transfer condition does not apply, and transferring the second communications for receipt by a different communication device if the transfer condition does apply.

2. The method of claim 1 further comprising transferring the second communications for receipt the wireless communication device if the transfer condition does apply.

3. The method of claim 1 wherein transferring the first communications for receipt by the wireless communication device comprises transferring the first communications to a first Internet address for the wireless communication device, and wherein transferring the second communications for receipt by the different communication device comprises transferring the second communications to a second Internet address for the different communication device.

4. The method of claim 3 further comprising, in the communication network, maintaining a database that relates the predetermined area to the second Internet address.

5. The method of claim 4 further comprising, in the communication network, maintaining the database to relate the predetermined area to the predetermined time period.

6. The method of claim 4 further comprising, in the communication network, maintaining the database to relate the predetermined area to a communication session type.

7. The method of claim 1 wherein the first communication and the second communication comprise voice communications.

8. The method of claim 1 wherein the first communication and the second communication comprise video communications.

9. The method of claim 1 wherein the predetermined area is less than 150 square feet.

10. The method of claim 1 wherein the predetermined time period is more than one minute.

11. A method of operating a communication network comprising:
in the communication network, receiving first communications directed to a wireless communication device and transferring the first communications for receipt by the wireless communication device;
in the wireless communication device, receiving the first communications;
in the wireless communication device, determining data that indicates locations of the wireless communication device correlated to time and processing the data to detect a transfer condition that comprises the wireless communication device being located within a predetermined area for a predetermined period of time and remaining within the predetermined area;
in the wireless communication device, transferring information for receipt by the communication network indicating whether the transfer condition applies;
in the communication network, receiving the information indicating whether the transfer condition applies; and
in the communication network, receiving second communications directed to the wireless communication device, transferring the second communications for receipt the wireless communication device if the transfer condition does not apply, and transferring the second communications for receipt by a different communication device if the transfer condition does apply.

12. The method of claim 11 further comprising transferring the second communications for receipt the wireless communication device if the transfer condition does apply.

13. The method of claim 11 wherein transferring the first communications for receipt by the wireless communication device comprises transferring the first communications to a first Internet address for the wireless communication device, and wherein transferring the second communications for receipt by the different communication device comprises transferring the second communications to a second Internet address for the different communication device.

14. The method of claim 13 further comprising, in the wireless communication device, maintaining a data association that relates the predetermined area to the different communication device, and wherein the information indicating whether the transfer condition applies also indicates the different communication device.

15. The method of claim 14 further comprising, in the communication network, processing the information indicating the different communication device to determine the second Internet address for the different communication device.

16. The method of claim 14 further comprising, in the wireless communication device, maintaining the data association to relate the predetermined area to a communication session type.

17. The method of claim 11 wherein the first communication and the second communication comprise voice communications.

18. The method of claim 11 wherein the first communication and the second communication comprise video communications.

19. The method of claim 11 wherein the predetermined area is less than 150 square feet.

20. The method of claim 11 wherein the predetermined time period is more than one minute.
